(19) United States
(12) Patent Application Publication
(10) Pub. No.: US 2026/0112390 A1
(43) Pub. Date: Apr. 23, 2026

(54) EVALUATION METHOD, MANUFACTURING METHOD, AND DISK DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Masafumi IWASHIRO, Yokohama Kanagawa (JP)

(21) Appl. No.: 19/194,794

(22) Filed: Apr. 30, 2025

(30) Foreign Application Priority Data
Oct. 17, 2024 (JP) 2024-181532

(51) Int. Cl. G11B 5/55; G11B 5/84; G11B 20/18

(52) U.S. Cl. CPC G11B 5/556; G11B 5/84; G11B 20/1816

(57) ABSTRACT

According to one embodiment, an evaluation method is provided. The evaluation method includes obtaining first accuracy information. The first accuracy information relates to positioning accuracy of the head when a head is caused to seek to a first radial position in a disk medium. The evaluation method includes determining whether the first radial position is good or poor depending on the first accuracy information.

### CROSS-REFERENCE TO RELATED APPLICATIONS

This application is based upon and claims the benefit of priority from Japanese Patent Application No. 2024-181532, filed on Oct. 17, 2024; the entire contents of which are incorporated herein by reference.

### FIELD

Embodiments described herein relate generally to an evaluation method, a manufacturing method, and a disk device.

### BACKGROUND

In a manufacturing process of a disk device having a disk medium, multiple tracks are defined for the disk medium, and then evaluation may be performed on each of the multiple tracks. In the manufacturing process of the disk device, it is desirable that evaluation be appropriately performed.

### BRIEF DESCRIPTION OF THE DRAWINGS

FIG. 1 is a diagram illustrating a schematic configuration of a disk device according to an embodiment;

FIG. 2 is a diagram illustrating a configuration of a control system of the disk device of the embodiment;

FIG. 3 is a flowchart illustrating seek processing of the embodiment;

FIG. 4 is a flowchart illustrating tracking processing of the embodiment;

FIG. 5 is a flowchart illustrating evaluation processing of an embodiment;

FIGS. 6A and 6B are diagrams illustrating the temporal change in the off-track amount in the embodiment (case where seek completion determination is flexible);

FIGS. 7A and 7B are diagrams illustrating a distribution of settling accuracy (positioning accuracy) for each radial position in the embodiment;

FIGS. 8A and 8B are diagrams illustrating the temporal change in the off-track amount in the embodiment (case where the seek completion determination is strict); and

FIGS. 9A and 9B are diagrams illustrating distributions of the number of samples required to be sought (seek time) for each radial position of the embodiment.

### DETAILED DESCRIPTION

In general, according to one embodiment, there is provided an evaluation method. The method includes obtaining positioning accuracy of a head when the head is caused to seek to a first radial position in a disk medium. The method includes determining whether the first radial position is good or poor depending on the obtained positioning accuracy.

Exemplary embodiments of an evaluation method will be explained below in detail with reference to the accompanying drawings. The present invention is not limited to the following embodiments.

### Embodiments

In a disk device of the embodiment, multiple tracks is defined for the disk medium in a manufacturing process of the disk device having a disk medium, and then evaluation is performed on each of the multiple tracks, in which a device for appropriately performing evaluation is provided.

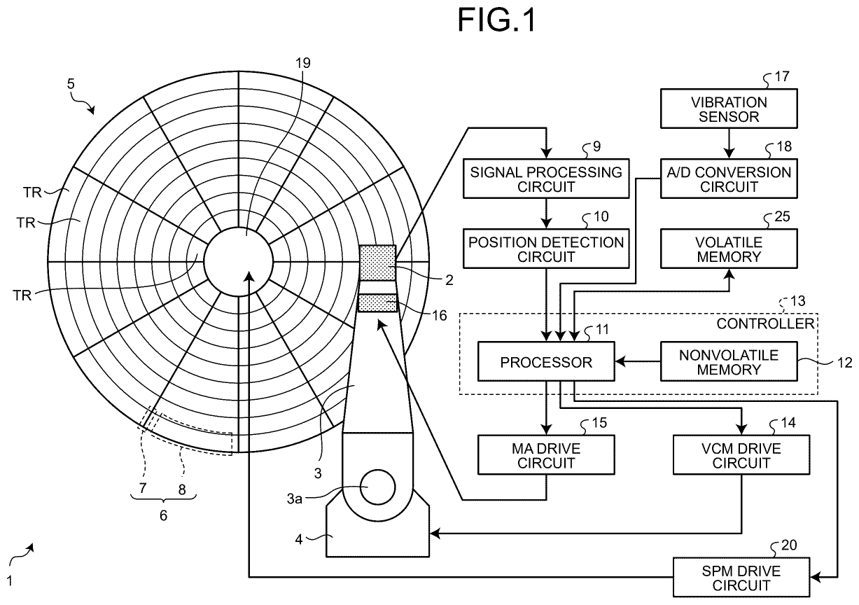

A disk device 1 can be configured as illustrated in FIG. 1. FIG. 1 is a diagram illustrating a schematic configuration of the disk device 1.

The disk device 1 includes a disk medium 5, a spindle motor (SPM) 19, an SPM drive circuit 20, a head 2, an arm 3, a voice coil motor (VCM) 4, a signal processing circuit 9, a position detection circuit 10, a controller 13, a voice coil motor (VCM) drive circuit 14, a microactuator (MA) drive circuit 15, a microactuator (MA) 16, a vibration sensor 17, and an A/D conversion circuit 18.

The controller 13 is capable of integrally controlling each unit of the disk device 1. A processor 11 and a nonvolatile memory 12 are included.

The disk medium 5 is rotatably supported by a housing (not illustrated) of the disk device 1 via the SPM 19. The SPM 19 is rotationally driven by the SPM drive circuit 20. The head 2 is provided corresponding to a recording plane of the disk medium 5. The head 2 can face the recording plane of the disk medium 5.

In the manufacturing process, servo information is written to the disk medium 5. In FIG. 1, illustrated are servo areas 7 radially arranged as an example of arrangement of the servo areas in which the servo information is written.

A data area 8 in which data can be written is provided between servo areas 7. One servo area 7 and one data area 8 subsequent to the servo area 7 constitute a servo sector 6. Based on a premise that the number of servo sectors of the disk medium 5 is N, with a reference sector numbered 0 on the circumference, numbers from 0 to N−1 are assigned in the rotation direction of the disk.

One servo area 7 is provided at the head of each servo sector 6 and records its servo information. The servo information includes position information indicating the position of the servo sector 6 in the disk medium 5. In the radial direction of the disk medium 5, multiple concentric servo tracks TR defined by servo information is set. Since the disk medium 5 rotates at a constant angular velocity, servo information is read by the head 2 at regular time intervals. A data area 8 can store data in response to a write command.

The head 2 includes a write element and a read element. In the head 2, the write element and the read element are installed in such a manner as to be shifted in the radial direction of the disk medium 5.

The head 2 is attached to the distal end of the arm 3. The arm 3 is rotatable about a shaft 3a provided between the arm 3 and the VCM 4.

The VCM 4 is driven by the VCM drive circuit 14 and can move the head 2 to seek along the radial direction of the disk medium 5 by driving the arm 3 to rotate about the shaft 3a.

The MA 16 is attached between the distal end of the arm 3 and the head 2. The MA 16 minutely moves the head depending on a given voltage.

The signal processing circuit 9 can demodulate a signal detected by the head 2 to generate a read signal and perform error correction on the read signal. The read signal includes data and servo information. The signal processing circuit 9 supplies the read signal to the position detection circuit 10.

The position detection circuit 10 separates data and servo information from the data signal. The position detection circuit 10 extracts position information from the servo information. The position detection circuit 10 obtains the position of the head 2 using the position information. The position detection circuit 10 supplies data and the position of the head 2 to the controller 13.

The processor 11 includes a central processing unit (CPU) and others.

The nonvolatile memory 12 stores firmware and parameters in a nonvolatile manner. The firmware includes description of various control methods. The parameters are used for various control methods. The nonvolatile memory 12 may be a flash memory.

The volatile memory 25 is connected to the processor 11. The volatile memory 25 can temporarily store information. The volatile memory 25 may be used as a work area by the processor 11.

The processor 11 can read the firmware from the nonvolatile memory 12 at the time of activation of the disk device 1 or the like, expand a functional module of the firmware on the volatile memory 25, and execute various control methods in accordance with the functional module of the firmware.

For example, the processor 11 can receive the position of the head 2 from the position detection circuit 10 at regular time intervals, obtain a position error from the target position of the head 2, and perform positioning control of the head 2 via the MA drive circuit 15 and the VCM drive circuit 14 such that the position error approaches 0.

The processor 11 reads the parameters from the nonvolatile memory 12 in accordance with the firmware, determines the control amount of the VCM 4 and the control amount of the MA 16 for each predetermined sample period, and supplies the control amount of the VCM 4 and the control amount of the MA 16 to the VCM drive circuit 14 and the MA drive circuit 15, respectively. The sample period may be constant.

The VCM drive circuit 14 controls the current flowing through the VCM 4 depending on the control amount of the VCM 4 by the processor 11. As a result, the VCM 4 is driven by an indicator current corresponding to the control amount of the VCM 4 by the processor 11.

The MA drive circuit 15 controls the voltage applied to the MA 16 depending on the control amount of the MA 16 by the processor 11. As a result, the MA 16 is driven by an indicator current corresponding to the control amount of the MA 16 by the processor 11.

The vibration sensor 17 can detect external vibration applied to the disk device 1. The vibration sensor 17 supplies a detection signal as a detection result to the A/D conversion circuit 18 in the form of an analog signal.

The A/D conversion circuit 18 A/D-converts the detection signal (analog signal) of the vibration sensor to generate detection information (digital signal). The A/D conversion circuit 18 supplies the detection information to the processor 11. As a result, the processor 11 can perform predetermined control in accordance with the detection information of the vibration sensor 17.

In the disk device 1, the controller 13 rotates the disk medium 5 at a constant angular velocity during operation. The controller 13 obtains the head position in accordance with servo information read from the servo area 7 at the head of each servo sector 6 in synchronization with the rotation angle of the disk medium 5. Therefore, the controller 13 functionally constitutes a sample value control system that determines input to a control target at regular time intervals. The controller 13 performs multi-rate control in which the VCM 4 and the MA 16 are driven in 1/N cycles (N is an integer greater than or equal to 2) of an observation cycle of the head position. The timing at which the analog value of the vibration sensor 17 is A/D-converted may be the same as the observation cycle of the head position or may be different from the observation cycle of the head position. Unlike the servo information on the disk medium 5, the timing of A/D conversion has less restriction. Therefore, the analog value of the vibration sensor 17 may be observed at multiple rates.

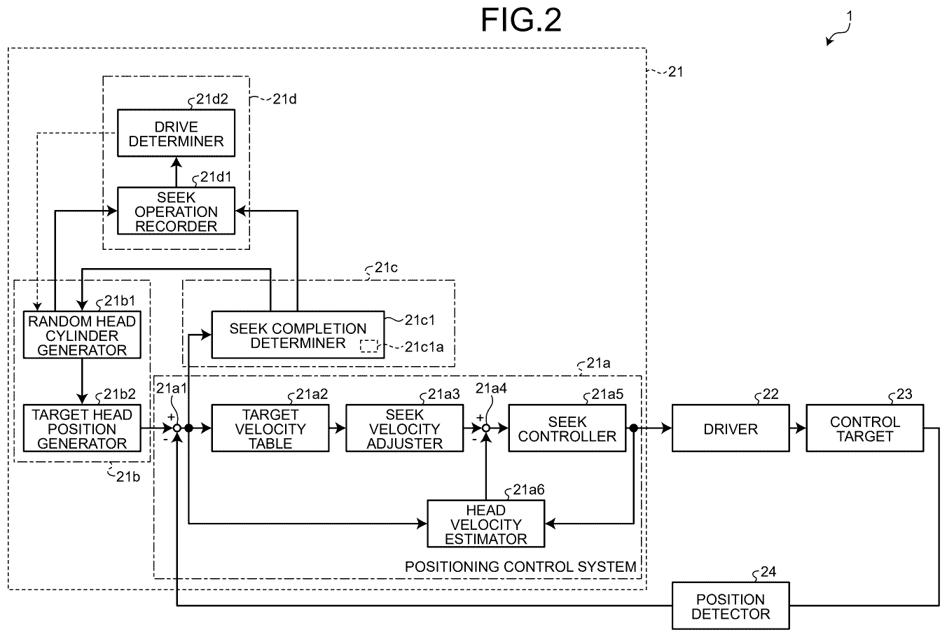

The disk device 1 has a random seek evaluation function and can be configured as illustrated in FIG. 2. FIG. 2 is a diagram illustrating the configuration of a control system of the disk device 1.

The disk device 1 includes a control unit 21, a driver 22, a control target 23, and a position detector 24. The control unit 21 corresponds to the controller 13. The driver 22 corresponds to the VCM drive circuit 14 and the MA drive circuit 15. The control target 23 corresponds to the head 2, the VCM 4, and the MA 16. The position detector 24 corresponds to the signal processing circuit 9 and the position detection circuit 10.

In the control unit 21, a block 21b that implements a seek operation, a block 21c that performs seek completion determination, and a block 21d that records and evaluates the seek operation are provided around a positioning control system 21a.

The positioning control system 21a includes a subtractor 21a1, a target velocity table 21a2, a seek velocity adjuster 21a3, a subtractor 21a4, a seek controller 21a5, and a head velocity estimator 21a6. The block 21b has a random head cylinder generator 21b1 and a target head position generator 21b2. The block 21c includes a seek completion determiner 21c1. The seek completion determiner 21c1 includes a seek counter 21c1a. The block 21d includes a seek operation recorder 21d1 and a drive determiner 21d2.

Note that the seek completion determiner 21c1 may be configured to be capable of selecting an off-track slice used for the seek completion determination from multiple mutually different off-track slices. An off-track slice having a relatively large value among the multiple off-track slices is used in a case where the seek completion determination is flexible. An off-track slice having a relatively small value among the multiple off-track slices is used in a case where the seek completion determination is strict.

Furthermore, although not illustrated for the sake of simplicity, the control unit 21 further includes a tracking processing unit that performs tracking processing. The tracking processing unit includes a tracking counter and an evaluation counter.

As terminology, a tracking operation immediately after completion of a seek operation is herein referred to as settling.

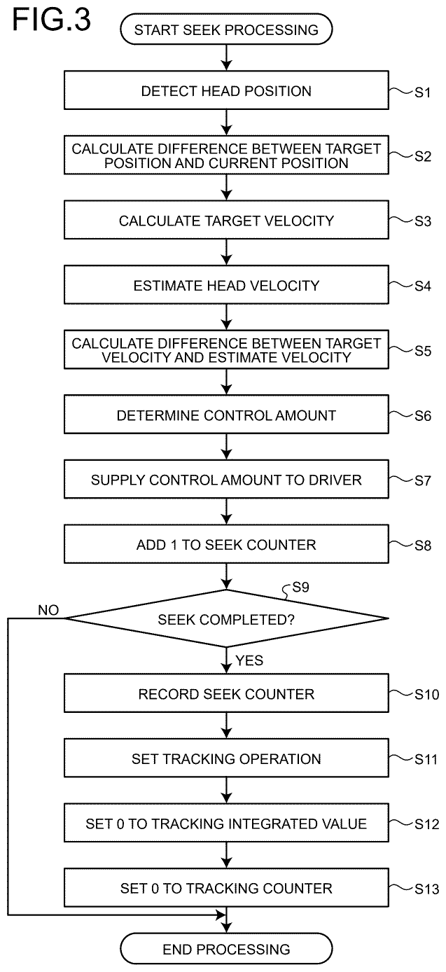

The disk device 1 performs seek processing as illustrated in FIG. 3. FIG. 3 is a flowchart illustrating seek processing of the disk device 1.

In the seek processing, the control unit 21 sets the operation mode of the head 2 to a seek mode. At this point, the seek completion determiner 21c1 may select an off-track slice used for the seek completion determination from multiple mutually different off-track slices. An off-track slice having a relatively large value among the multiple off-track slices is used in a case where the seek completion determination is flexible. An off-track slice having a relatively small value among the multiple off-track slices is used in a case where the seek completion determination is strict.

The position detector 24 detects the head position (S1) and supplies the head position to the subtractor 21a1. The target head position generator 21b2 supplies the target position to the subtractor 21a1. The subtractor 21a1 calculates a difference of the head position from the target position (S2) and supplies the difference to the target velocity table 21a2. The target velocity table 21a2 calculates a target velocity by, for example, dividing the difference by the sample period (S3) and supplies the target velocity to the subtractor 21a4. The head velocity estimator 21a6 estimates the head velocity depending on the difference of the head position from the target position and the control amount of the seek controller 21a5 (S4) and supplies the head velocity to the subtractor 21a4. The subtractor 21a4 calculates the difference of the estimated head velocity from the target velocity (S5) and supplies the difference to the seek controller 21a5. The seek controller 21a5 determines the control amount depending on the difference (S6) and supplies the control amount to the driver 22 (S7). The control amount includes the indicator current of the VCM 4 and the indicator current of the MA 16.

Thereafter, the seek completion determiner 21c1 adds 1 to the count value of the seek counter 21c1a (S8). The count value of the seek counter 21c1a indicates the number of samples after the seek has been started. The seek completion determiner 21c1 performs seek completion determination (S9) and supplies the determination result to the random head cylinder generator 21b1 and the seek operation recorder 21d1. The seek completion determiner 21c1 determines that the seek has not been completed in a case where the off-track amount of the head 2 exceeds the off-track slice and determines that the seek has been completed in a case where the off-track amount of the head 2 falls within the off-track slice.

If it is determined that the seek has been completed (Yes in S9), the seek operation recorder 21d1 records the count value of the seek counter 21c1a at that time as the number of seek execution samples (S10). The control unit 21 performs tracking operation setting (S11). The control unit 21 initializes the tracking integrated value as setting of a tracking integrated value (S12). The control unit 21 initializes the tracking counter as setting of the tracking counter (S13).

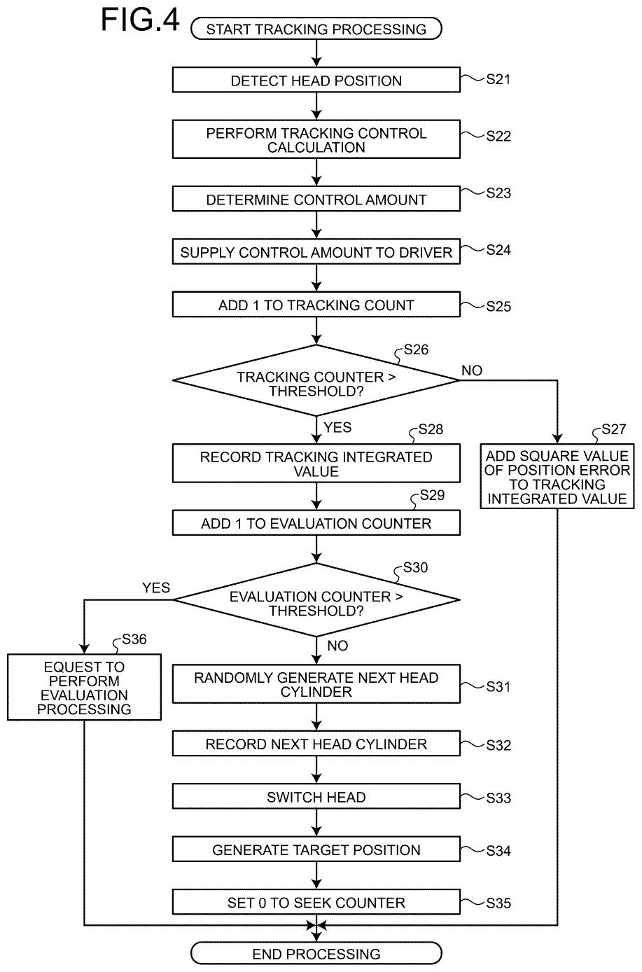

Thereafter, the control unit 21 switches the operation mode of the head 2 from a seek mode to a tracking mode, and performs tracking processing as illustrated in FIG. 4. FIG. 4 is a flowchart illustrating the tracking processing of the disk device 1.

In the tracking processing, the position detector 24 detects the head position (S21) and supplies the head position to the positioning control system 21a. The positioning control system 21a performs tracking control calculation (22), determines a control amount (S23), and supplies the control amount to the driver 22 (S24). The control amount includes the indicator current of the VCM 4 and the indicator current of the MA 16.

Then, the control unit 21 adds 1 to the count value of the tracking counter (S25). The count value of the tracking counter indicates the number of samples after execution of tracking has been started.

The control unit 21 determines whether the count value of the tracking counter exceeds a threshold (S26).

If the count value of the tracking counter is smaller than or equal to the threshold (No in S26), the control unit 21 adds a square value of the head position error as of the time of sampling to the tracking integrated value (S27).

If the count value of the tracking counter exceeds the threshold (Yes in S26), the control unit 21 records the tracking integrated value as the settling accuracy (S28) and adds 1 to the count value of the evaluation counter (S29).

The control unit 21 determines whether or not the count value of the evaluation counter exceeds a threshold (S30).

If the count value of the evaluation counter is smaller than or equal to the threshold (No in S30), the control unit 21 randomly generates a head cylinder for next seek by the random head cylinder generator 21b1 (S31) and records the head cylinder for the next seek in the seek operation recorder 21d1 (S32). Then, the control unit 21 switches the operation mode of the head 2 from the tracking mode to the seek mode (S33), generates a target position by the target head position generator 21b2 (S34), and initializes the count value of the seek counter to 0 (S35).

Note that the multiple tracks TR in the disk medium 5 is defined by the servo information recorded in the servo areas 7; however, there may be a local portion where the track pitch varies a lot due to an error at the time of manufacturing or the like. In this case, if data is written to and/or read from a portion where the track pitch variation is large, a write error and/or a read error frequently occur, and the performance of the disk device 1 may be deteriorated.

Meanwhile, if the count value of the evaluation counter exceeds the threshold (Yes in S30), the control unit 21 requests the block 21d to perform evaluation processing as background processing (S36). The evaluation processing is performed to find a portion having a large variation in the track pitch by evaluating the seek operation and to register the portion as an error area.

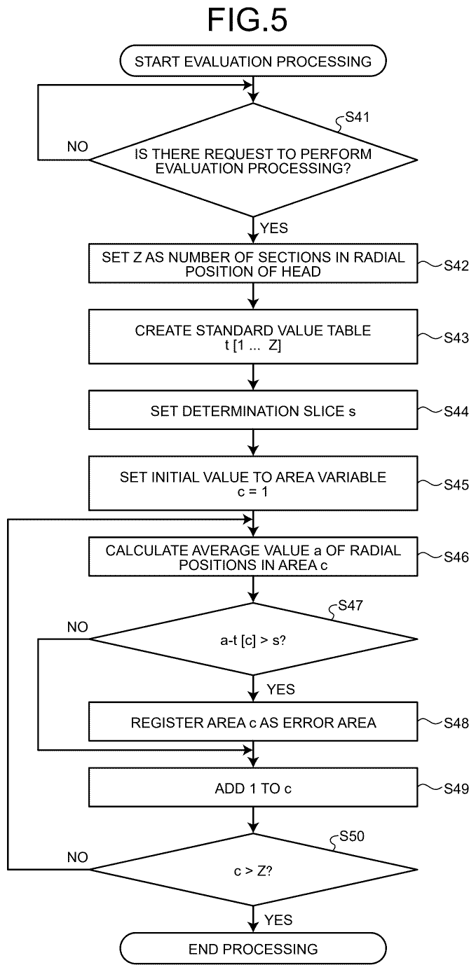

For example, the block 21d may perform the evaluation processing as illustrated in FIG. 5. FIG. 5 is a flowchart illustrating the evaluation processing.

The block 21d waits until there is an evaluation processing execution request (No in S41). If there is an evaluation processing execution request (Yes in S41), the block 21d sets the number of sections in the radial position of the head 2 to ‘Z’ (S42). Z is an integer greater than or equal to 2. The number of sections Z corresponds to the number of tracks to be evaluated. In a case of evaluating all tracks, the number of sections Z may be the same as the number of tracks. In a case where evaluation is performed by thinning out for every ‘N’ tracks, the number of sections Z may be a number that is N times smaller than the number of tracks. N is an integer greater than or equal to 2. Identification information of each section may be a number from 1 to N.

The block 21d generates a standard value table t[1 . . . Z] indicating the track center position for each section (S43). In the standard value table t[1 . . . Z], identification information of a section and the track center position are associated with each other for multiple sections. A track center position corresponding to a section can be specified by referring to the standard value table t[1 . . . Z]. The standard value table t[1 . . . Z] can also be regarded as a sequence that returns a corresponding track center position when given identification information of a section.

The block 21d sets a determination slice to be used for evaluation to ‘s’ (S44). The determination slice s corresponds to an allowable limit of the off-track amount. The determination slice s corresponds to an off-track slice used for seek completion determination. In a case where the off-track slice used for the seek completion determination is relatively large (a case where the seek completion determination is flexible), the determination slice s is set to a relatively large value. In a case where the off-track slice used for the seek completion determination is relatively small (a case where the seek completion determination is strict), the determination slice s is set to a relatively small value.

The block 21d sets an initial value 1 to an area variable ‘c’ that specifies a section to be evaluated (S45). The area variable c stores identification information of a section. The initial value 1 is identification information of a section to be selected first.

The block 21d calculates an average value a of radial positions in an area c (S46). The block 21d may acquire the radial position of the head 2 for multiple circumferential positions at the timing when a predetermined period of time Δt has elapsed from seek completion timing. The block 21d may calculate the average value a of the radial positions by weighted-averaging the acquired radial positions of the head 2 at multiple circumferential positions.

The block 21d determines whether the average value a of the radial positions obtained in S46 satisfies the following (S47).

a−t[c]>s Formula 1

t[c] indicates the track center position of the area c. a−t[c] represents the average value of off-track amounts of the head 2 in the area c. Formula 1 being satisfied means that the average value of the off-track amounts of the head 2 exceeds the determination slice s and that the area is a portion where the variation in the track pitch is large.

If the average value a of the radial positions obtained in S46 satisfies Formula 1 (Yes in S47), the block 21d registers the area c as an error area (S48). For example, error area information may be stored in a management information storage area of the disk medium 5 or the nonvolatile memory 12. In the error area information, track identification information and an error flag may be associated with each other for multiple tracks. The block 21d may acquire the error area information from the management information storage area of the disk medium 5 or the nonvolatile memory 12, and update by overwriting the error flag corresponding to identification information of a track corresponding to the area c from 0 (non-active) to 1 (active). As a result, the controller 13 can write and/or read data while avoiding the error area in which the error flag is active in a subsequent write operation and/or read operation. As a result, the performance of the disk device 1 can be improved. Alternatively, if the average value a of the radial positions obtained in S46 does not satisfy Formula 1 (No in S47), the block 21d skips S48.

The block 21d adds 1 to the area variable c (S49) and changes the evaluation target to a next area.

The block 21d repeats the processing from S46 to S49 until the area variable c exceeds the number of sections Z (No in S50) and ends the processing when the area variable c exceeds the number of sections Z (Yes in S50). As a result, the evaluation processing can be sequentially performed for each of the sections 1 to N, and a portion having a large variation in the track pitch can be found and registered as an error area.

Next, an example of a result of the evaluation processing by the block 21d will be described.

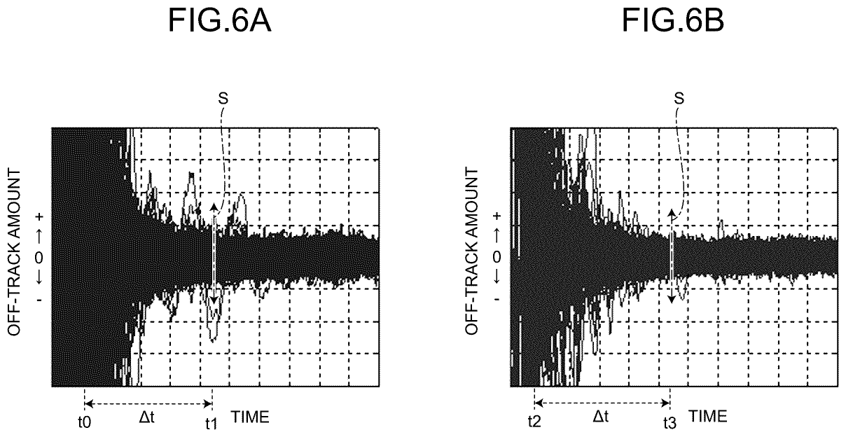

In a case where the off-track slice used for the seek completion determination is relatively large (a case where the seek completion determination is flexible), as illustrated in FIGS. 6A and 6B, the residual vibration of the head 2 is not settled at timing t0 and t2 at which the seek is completed, and the off-track amount of the head 2 is relatively large. FIGS. 6A and 6B are diagrams illustrating the temporal change in the off-track amount (a case where the seek completion determination is flexible). At this point, the determination slice s in S47 illustrated in FIG. 5 is set to a relatively large value. In the radial position where the variation in the track pitch is large, the off-track amount is larger than the determination slice s as indicated by the dashed-dotted line arrow in FIG. 6A at timing t1 at which the predetermined period of time Δt has elapsed from completion of seek. In the radial position where the variation in the track pitch is small, the off-track amount is within the determination slice s as indicated by the dashed-dotted line arrow in FIG. 6B at timing t3 at which the predetermined period of time Δt has elapsed from completion of seek. As a result, in S47 and S48 of FIG. 5, an area corresponding to FIG. 6A can be determined as an error area, and an area corresponding to FIG. 6B can be determined as not being an error area.

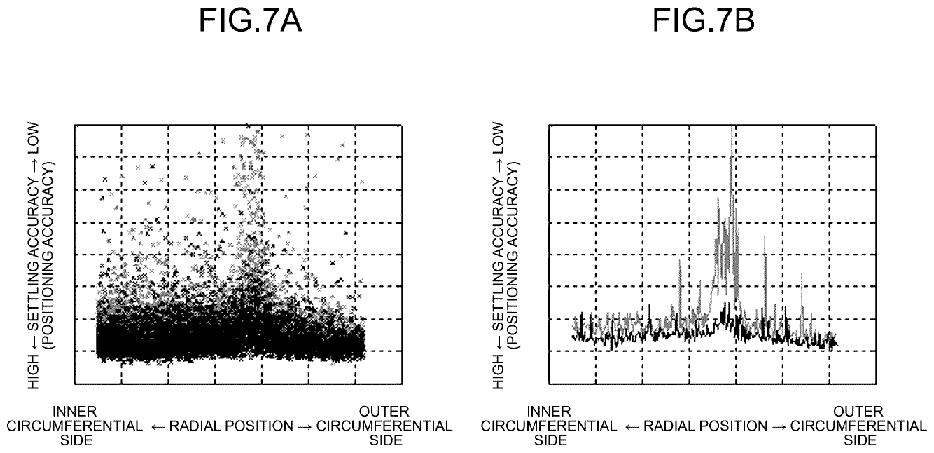

Arranging the results illustrated in FIGS. 6A and 6B for multiple radial positions give results as illustrated in FIGS. 7A and 7B. FIGS. 7A and 7B are diagrams illustrating a distribution of settling accuracy for each radial position. The settling accuracy indicates the accuracy of how well settling can be completed within a predetermined period of time Δt. The settling accuracy corresponds to the positioning accuracy of the head 2.

FIG. 7A is obtained by plotting the settling accuracy as it is for multiple radial positions, and FIG. 7B is obtained by weighted-averaging the settling accuracy at multiple circumferential positions. As illustrated in FIGS. 7A and 7B, it can be seen that the settling accuracy decreases at radial positions where the variation in the track pitch is large as compared with that at radial positions where the variation in the track pitch is small. This tendency is more remarkable in FIG. 7B than in FIG. 7A, and thus it can be seen that the determination accuracy of an error area in S47 and S48 can be improved by averaging the radial positions as in S46 of FIG. 5.

Note that, in FIGS. 7A and 7B, gray indicates an evaluation result of the disk device having small variation in the track pitch in general, and black indicates an evaluation result of the disk device having large variation in the track pitch in general.

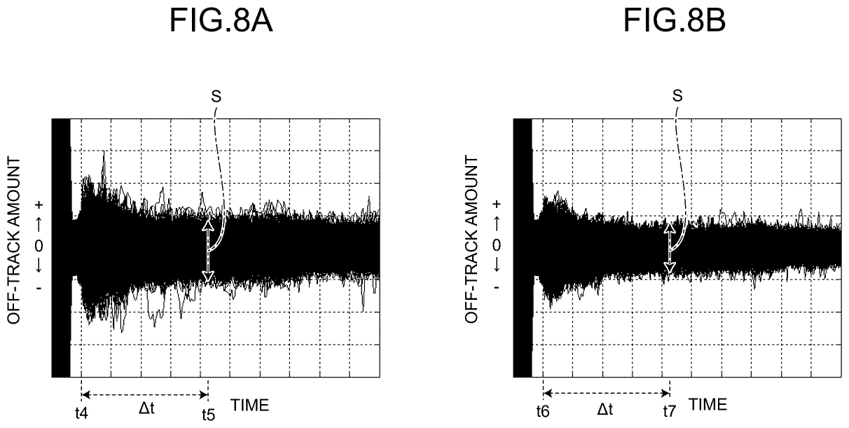

In a case where the off-track slice used for the seek completion determination is relatively small (a case where the seek completion determination is strict), as illustrated in FIGS. 8A and 8B, the residual vibration of the head 2 is settled at timing t5 and t7 at which the seek is completed, and the off-track amount of the head 2 is relatively small. FIGS. 8A and 8B are diagrams illustrating a temporal change in the off-track amount (a case where the seek completion determination is strict). At this point, the determination slice s in S47 illustrated in FIG. 5 is set to a relatively small value; however, the difference between the off-track amount at the radial positions, where the variation in the track pitch is large illustrated in FIG. 8A, and the off-track amount at the radial positions, where the variation in the track pitch is small illustrated in FIG. 8B, is small. For this reason, the determination accuracy of an error area in S47 and S48 in FIG. 5 is prone to a decrease.

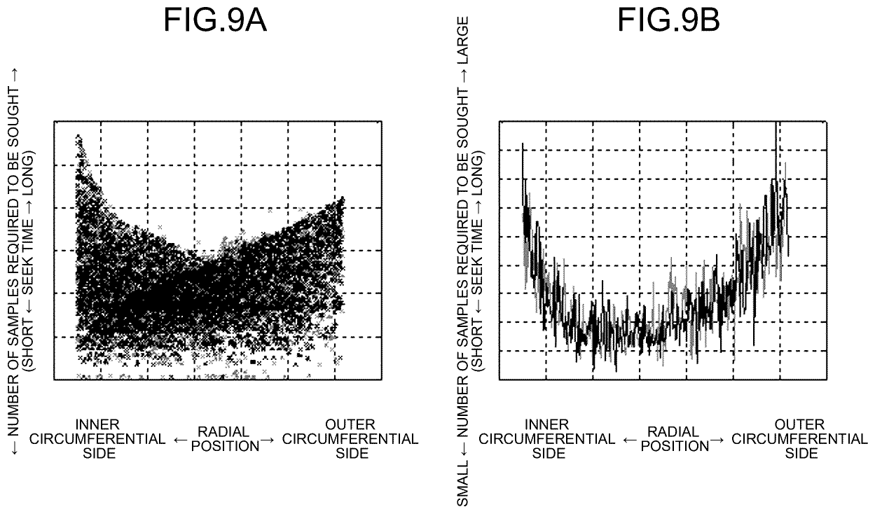

Meanwhile, in a case where the off-track slice used for the seek completion determination is relatively small (in a case where the seek completion determination is strict), by using the number of samples required to be sought, it is possible to clearly distinguish between a radial position where the variation in the track pitch is large and a radial position where the variation is small as illustrated in FIGS. 9A and 9B. The number of samples required to be sought is the number of sample periods from the start of seek to completion of the seek. Considering that the sample period is constant, it can be said that the number of samples required to be sought corresponds to seek time.

FIG. 9A is obtained by plotting the number of samples required to be sought as it is for multiple radial positions, and FIG. 9B is obtained by weighted-averaging the number of samples required to be sought at multiple circumferential positions. As illustrated in FIGS. 9A and 9B, it can be seen that the number of samples required to be sought is large (that is, the seek time is longer) at radial positions where the variation in the track pitch is large as compared with that at radial positions where the variation in the track pitch is small. This tendency is more remarkable in FIG. 9B than in FIG. 9A, and thus it can be seen that the determination accuracy of an error area in S47 and S48 can be improved by averaging the radial positions as in S46 of FIG. 5.

Note that, in FIGS. 9A and 9B, gray indicates an evaluation result of the disk device having small variation in the track pitch in general, and black indicates an evaluation result of the disk device having large variation in the track pitch in general.

As described above, in the disk device 1 of the embodiment, the controller 13 evaluates the settling accuracy of the head 2 for each radial position and determines whether the radial position is good or poor. Alternatively, the controller 13 evaluates the number of samples required to be sought of the head 2 for each radial position and determines whether the radial position is good or poor. As a result, the controller 13 can write and/or read data while avoiding a radial position determined to be poor in a subsequent write operation and/or read operation. As a result, the performance of the disk device 1 can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An evaluation method comprising:
obtaining positioning accuracy of a head when the head is caused to seek to a first radial position in a disk medium; and
determining whether the first radial position is good or poor depending on the obtained positioning accuracy.

2. The evaluation method according to claim 1,
wherein determining whether the first radial position is good or poor is performed as background processing of positioning control of the head.

3. The evaluation method according to claim 1, further comprising:
selecting a determination criterion from multiple determination criteria,
wherein determining whether the first radial position is good or poor includes
determining whether the first radial position is good or poor depending on the selected determination criterion and the obtained positioning accuracy.

4. The evaluation method according to claim 3,
wherein selecting the determination criterion includes setting a value selected from multiple values to a determination slice, and
determining whether the first radial position is good or poor includes
determining whether the first radial position is good or poor depending on the set determination slice and an off-track amount of the head.

5. The evaluation method according to claim 4,
wherein determining whether the first radial position is good or poor further includes
registering the first radial position as an error area in a case where the off-track amount of the head exceeds the set determination slice.

6. An evaluation method comprising:
obtaining a number of samples required to be sought until positioning of a head is completed when the head is caused to seek to a first radial position in a disk medium; and
determining whether the first radial position is good or poor depending on the obtained number of samples required to be sought.

7. The evaluation method according to claim 6,
wherein determining whether the first radial position is good or poor is performed as background processing of positioning control of the head.

8. The evaluation method according to claim 6, further comprising:
selecting a determination criterion from multiple determination criteria,
wherein determining whether the first radial position is good or poor includes
determining whether the first radial position is good or poor depending on the selected determination criterion and the obtained number of samples required to be sought.

9. The evaluation method according to claim 8,
wherein selecting the determination criterion includes setting a value selected from multiple values to a determination slice, and
determining whether the first radial position is good or poor includes
determining whether the first radial position is good or poor depending on the set determination slice and the obtained number of samples required to be sought.

10. The evaluation method according to claim 4,
wherein determining whether the first radial position is good or poor further includes registering the first radial position as an error area in a case where the obtained number of samples required to be sought exceeds the set determination slice.

11. A manufacturing method of a disk device, the method comprising:
performing evaluation by the evaluation method according to claim 1; and
applying a setting according to the evaluation to the disk device.

12. A disk device comprising:
a head;
a disk medium; and
a controller that obtains positioning accuracy of the head when the head is caused to seek to a first radial position in the disk medium and determines whether the first radial position is good or poor depending on the obtained positioning accuracy.

13. The disk device according to claim 12,
wherein the controller performs the determination as to whether the first radial position is good or poor as background processing of positioning control of the head.

14. The disk device according to claim 12,
wherein the controller selects a determination criterion from multiple determination criteria and determines whether the first radial position is good or poor depending on the selected determination criterion and the obtained positioning accuracy.

15. The disk device according to claim 14,
wherein the controller selects the determination criterion by setting a value obtained by selecting the value from multiple values to a determination slice, and
the controller determines whether the first radial position is good or poor by determining whether the first radial position is good or poor depending on the set determination slice and an off-track amount of the head.

16. The disk device according to claim 14,
wherein the controller registers the first radial position as an error area in a case where the off-track amount of the head exceeds the set determination slice.

17. A disk device comprising:
a head;
a disk medium; and
a controller that obtains a number of samples required to be sought until positioning of the head completes when the head is caused to seek to a first radial position in the disk medium and determines whether the first radial position is good or poor depending on the obtained number of samples required to be sought.

18. The disk device according to claim 17,
wherein the controller performs the determination as to whether the first radial position is good or poor as background processing of positioning control of the head.

19. The disk device according to claim 17,
wherein the controller selects a determination criterion from multiple determination criteria and determines whether the first radial position is good or poor depending on the selected determination criterion and the obtained number of samples required to be sought.

20. The disk device according to claim 19,
wherein the controller selects the determination criterion by setting a value obtained by selecting the value from multiple values to a determination slice, and
the controller determines whether the first radial position is good or poor by determining whether the first radial position is good or poor depending on the set determination slice and the obtained number of samples required to be sought.
